(19) United States
(12) Patent Application Publication
(10) Pub. No.: US 2002/0198821 A1
(43) Pub. Date: Dec. 26, 2002

(54) Method and apparatus for matching risk to return

(76) Inventor: Rodrigo Munoz, Fairfield, CA (US)

Correspondence Address: BUCKLEY, MASCHOFF, TALWALKAR, & ALLISON, 5 ELM STREET, NEW CANAAN, CT, 06840, US

(21) Appl. No.: 09/886,912

(22) Filed: Jun. 21, 2001

(51) Int. Cl. G06F 17/60

(52) U.S. Cl. 705/38

(57) ABSTRACT

A system, apparatus, method, computer program code and means for matching a level of risk to an expected return for a financial product includes selecting a first and a second investment option and a duration. A risk and a corresponding return on investment for each of said investment options are calculated based on the duration. An efficient frontier is then calculated between the first and second investment options, where the efficient frontier defines a number of risks and corresponding expected returns on investment for the financial product.

### CROSS REFERENCE TO RELATED APPLICATIONS

This application is related to commonly-owned U.S. patent application Ser. No. ______, filed Jun. 21, 2001 (on even date herewith), Attorney Docket No. G03.011 for “METHOD AND APPARATUS FOR EVALUATING AN APPLICATION FOR A FINANCIAL PRODUCT”, and U.S. patent application Ser. No. ______, filed Jun. 21, 2001 (on even date herewith), Attorney Docket No. G03.012 for “METHOD AND APPARATUS FOR RISK BASED PRICING”, the contents of each of which are incorporated by reference in their entirety for all purposes.

### BACKGROUND OF THE INVENTION

The present invention relates to methods and apparatus for making decisions regarding the approval of financial applications.

Financial institutions offer a wide variety of different financial products to consumers and other entities (“applicants”). These products, such as loans or leases, are approved or disapproved based on information regarding a particular applicant and other information relating to the transaction. Particularly with respect to financial products offered to consumer applicants, financial institutions traditionally make approval decisions based primarily on the applicant's credit risk. Typically, an application for a financial product is received and “scored” using one or more credit risk models. Typical credit risk models include proprietary models or fee-based models such as those offered by Equifax, Experian, or TransUnion (both of which generate so-called “FICO” scores based on a model developed by Fair, Isaac).

Use of these models, however, still requires that one or more individuals at the financial institution be given the final authority to approve a financial application. For example, an individual credit manager at a financial institution may be authorized to utilize his or her best judgment to make a final approval or disapproval of a consumer loan application after it has been scored using one or more credit risk models. That is, the credit manager uses his or her judgment to determine whether to, for example, lend money to an individual applicant with a given credit score. Unfortunately, this process can lead to inconsistent lending practices (e.g., one credit manager may approve a loan to an individual with a marginal FICO score, while another manager may deny a similarly-situated individual).

Some consistency of application has been achieved through the use of tiered products. For example, a financial institution which provides leases for automobiles may establish several tiers of lease products, each having different criteria for eligibility, one of which is related to the applicant's credit score. This allows differential pricing of products based on historical performance within each product, and also eliminates some of the inconsistency of approvals which can result from blanket reliance on the discretion of credit managers.

However, there could be high risk deals within a tier, especially when the risk is near the tier cutoff. For certain types of financial products, there could also be collateral risk (e.g., where the collateral is an automobile, a particular automobile may have a faster than average depreciation rate). By simply approving or disapproving applications based on credit risk and loss risk calculations, the return on investment for a particular application may not be maximized. Further, too many applications must be approved manually. This can be a drain on resources and can lead to inconsistent application of approval standards.

There is a need for a system and method which allows a financial institution to establish objectives for matching risk to return, allowing the institution to make better-informed approval decisions for financial products and to achieve desired returns from its overall portfolio.

Harry Markowitz, in “Portfolio Selection”, Journal of Finance, March 1952, pp 77-91 (the contents of which are incorporated herein in their entirety for all purposes, and referred to herein as the “Markowitz Principle”), described a method for financial portfolio management in which an efficient frontier is established identifying all of the optimal portfolio mixes for securities in which each point on the frontier represents the maximum return achievable through mixing specific investments in securities for a given level of risk. This Markowitz Principle is quite useful for assisting in the development of portfolios of securities where risk is estimated using standard deviation and return is based on annual expected return, or yield. Applicants are unaware of any application of the Markowitz Principle to financial product approval or pricing techniques.

There is a need for a system and method which allows a financial institution or other entity to generate an efficient frontier in a manner enabling the entity to make better-informed approval decisions for financial products and to achieve desired returns from its overall portfolio.

It would further be desirable to provide a system and method which reduces the amount of manual approval required in the financial application approval process. It would further be desirable to provide a system and method which allows a financial institution to maximize its return on investment for financial products, such as loans and leases. It would further be desirable to provide such a system which is automated and which allows remote interaction over public or private networks.

### SUMMARY OF THE INVENTION

To alleviate the problems inherent in the prior art, and to provide an improved decision making tool for approving or declining financial applications and for managing portfolios of financial products, embodiments of the present invention provide a system, apparatus, method, computer program code and means for matching a level of risk to an expected return for a financial product.

In one embodiment, a system, apparatus, method, computer program code and means for matching a level of risk to an expected return for a financial product includes selecting a first and a second investment option and a duration. A risk and a corresponding return on investment for each of said investment options are calculated based on the duration. An efficient frontier is then calculated between the first and second investment options, where the efficient frontier defines a number of risks and corresponding expected returns on investment for the financial product.

According to further embodiments, a system, apparatus, method, computer program code and means for evaluating an application for a financial product are provided which matches risk to return. This embodiment includes establishing an efficient frontier defining a plurality of expected returns on investment associated with a plurality of risks of loss. Application data defining an application for a financial product are received. A calculated risk of loss associated with the application is calculated and used, at least in part, to calculate an expected return on investment for the application. The expected return on investment is compared to a pre-determined, or return on investment “hurdle” associated with the calculated risk of loss. In one embodiment, the application will be approved if the expected return is greater than or equal to the return hurdle. The application may be denied if the expected return calculated for the application is less than the return hurdle. In some embodiments, the price or term of the financial product may be varied to ensure that the expected return on investment is equal to or greater than the return on investment hurdle at the calculated level of risk.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a flow diagram depicting a process for calculating an efficient frontier to match risk to return according to one embodiment of the present invention;

FIG. 2A is a flow diagram depicting a process for making product approval decisions using embodiments of the present invention;

FIG. 2B is a flow diagram depicting a process for making product approval and pricing decisions using embodiments of the present invention;

FIG. 3 is a block diagram of a system consistent with the present invention;

FIG. 4 is a block diagram of a lender device of the system of FIG. 3 pursuant to an embodiment of the present invention; and

FIG. 5 is a chart depicting exemplary efficient frontier data calculated by and/or used in the system of FIG. 3.

### DETAILED DESCRIPTION

Applicants have recognized that there is a need to help financial institutions and other vendors of financial products to identify appropriate returns on investment for their products. In particular, Applicants have recognized a need to provide financial institutions and other vendors of financial products with an ability to appropriately match levels of risk with expected returns on investment.

For the purposes of describing embodiments of the present invention, a number of terms will be used herein. As used herein, the term “financial institution” will be used to refer to a bank, credit union, or other lender or entity that extends credit to or otherwise underwrites financial products to applicants. As used herein, the term “lender” may be used interchangeably with the term “financial institution”. As used herein, the term “applicant” is used to refer to an individual or entity which is applying for approval of a financial product offered by a financial institution. As used herein, the term “financial product” is used to refer to a loan, lease, or other item of credit extended by a financial institution to an applicant. As used herein, the term “price” is used to refer to a fee or other cost of funds of a financial product which will be received by the financial institution if an application is approved. Example “prices” include the annual percentage rate (APR) received by a financial institution for a loan, or basis points received by a financial institution for a lease product. The “price” may also include the monthly payments for a loan or lease product. Other types of “prices” are known to those skilled in the art.

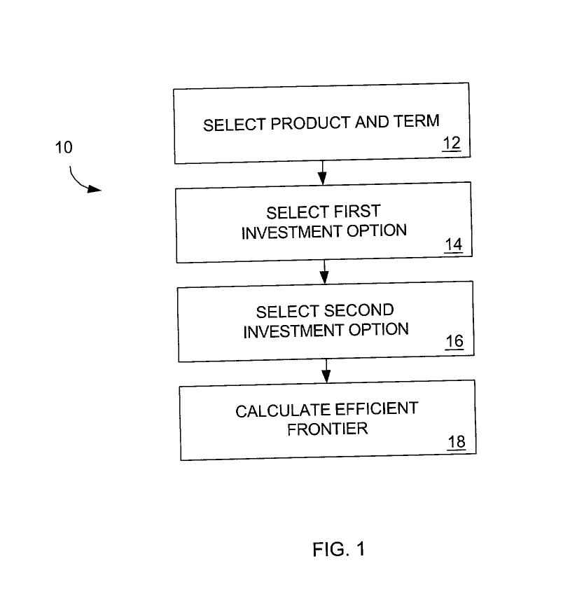

Referring now to FIG. 1, a process 10 is shown according to one embodiment of the present invention. Process 10 may be conducted by, or on behalf of, a financial institution to allow the financial institution to make establish expected returns on investment (ROI) for different financial products at varying levels of risk. Process 10 may be performed on a regular basis by or on behalf of a financial institution as a method of establishing profitability targets and objectives for its financial products.

According to the invention, processing commences at 12 where a product and a term are selected. For example, if a financial institution wishes to utilize features of the present invention to match risk to return for automobile loans, it may choose to do so for a variety of different automobile loan terms (e.g., 16, 38 and 60 months—recognizing that customer defaults are common which will impact the effective term of the loan or lease, therefore the term will be referred to as the “expected effective term”). For the purposes of illustrating features of the invention, an exemplary financial institution will be described which wishes to use features of the invention to establish ROI objectives for an automobile loan product with an expected effective term of 38 months.

Processing continues at 14, where a first investment option is selected. In one embodiment, the first investment option is selected to have little or no volatility (risk). Preferably, the first investment option is one which can be held for the same term as the expected effective term of the financial product (e.g., loan or lease). Further, for any company using financial leverage (e.g., some level of debt), the first investment option preferably is selected to have a yearly return or yield equal to the cost of funds for that period. This will be the no risk point, because for any company working as an ongoing concern, debt has to be paid with no volatility (that is the contracted amount must be paid within the contracted time). Applicants believe that Zero Coupon Bonds or Coupon bonds are suitable for representing this no risk investment option, although those skilled in the art will recognize that other potential investments may also be suitable for the first investment option.

The expected ROI for an investment in the first selected investment option is calculated as the lifetime net income divided by the lifetime annualized net investment (ANI) for an investment in the low risk item for the investment period (in the example, the investment period, or expected effective term, is 38 months). In one embodiment, the first investment option is an investment in a Zero Coupon bond yielding the cost of funds for the investment period (having, by definition, no risk).

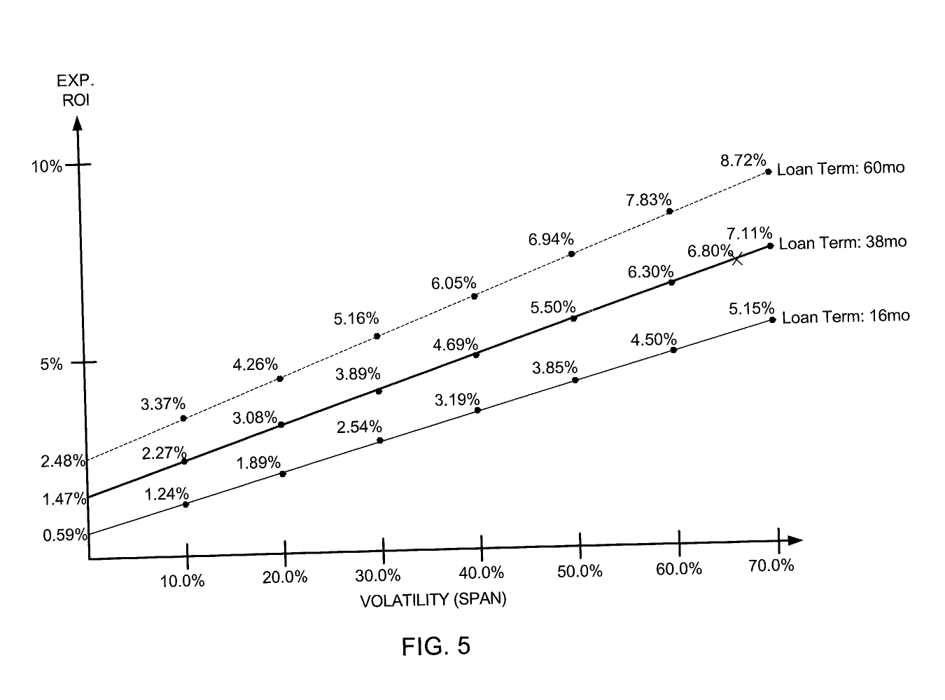

Processing continues at 16, where a second investment option is selected. In one embodiment, the second investment option is selected to have a higher risk than the first investment option. Preferably, the second investment option is one which achieves a known or calculable return on investment for a known or calculable risk. In one embodiment, the second investment option is selected to represent the overall market. For example, in one embodiment, the second investment option is an investment in the Standard & Poors (S&P) 500 index of securities for a period equal to the expected effective term of the financial product. In one embodiment, the expected ROI for an investment in the second investment option is calculated (again, using the calculation lifetime net income divided by the lifetime ANI for the investment period). In one embodiment, the calculation is repeated for the life of the S&P 500 to normalize the calculated risk (e.g., the calculations are performed based on S&P 500 results from 1950 to 2000). These calculations will be described below in more detail in conjunction with a description of the chart of FIG. 5.

Once the risk and return values have been calculated for the first investment option (the low risk option) and the second investment option (the higher risk option), an efficient frontier may be described by calculating the slope and the intercept of the line between the values for the first and second investment options. The portfolio combination of a zero risk investment with a higher risk investment, pursuant to the Markowitz Principle, results in a portfolio having the highest expected return for a given level of risk.

According to the invention, this line (e.g., as shown and described below in conjunction with FIG. 5 as an example) defines an efficient frontier with a number of risk values matched to expected returns. For example, continuing the example where the financial product is an automobile loan having an expected effective term of 38 months, where the low risk option is an investment in Zero Coupon bonds, and where the high risk option is an investment in the S&P 500, a slope of 8.06% with an intercept of 1.47% may be calculated. This defines an efficient frontier for that particular product which may be used to guide product approval decisions for the financial institution. That is, the financial institution may utilize the efficient frontier to determine the appropriate return at a given risk. An applicant for an automobile loan who poses a risk of loss of 40.00% and an expected effective term of 38 months should only be approved for a loan if the overall ROI which can be realized is approximately 4.69%.

Financial institutions may also utilize the efficient frontier to remain competitive. For example, an applicant for an automobile loan who poses a risk of loss of 40.00% should probably not be charged a price for the loan at which the financial institution would realize a ROI of greater than 5.00% because the applicant will likely receive a better price elsewhere. Features of embodiments of the present invention permit financial institutions to make decisions regarding applications in a manner which maximizes the institution's return on investment for given levels of risk. Those skilled in the art will recognize that a financial institution or other entity which uses features of the present invention may establish different efficient frontiers based on their risk tolerance and appetite for returns. For example, a less volatile second investment option may be selected than the S&P 500. Alternatively, a more volatile second investment option may be selected to increase risk and return.

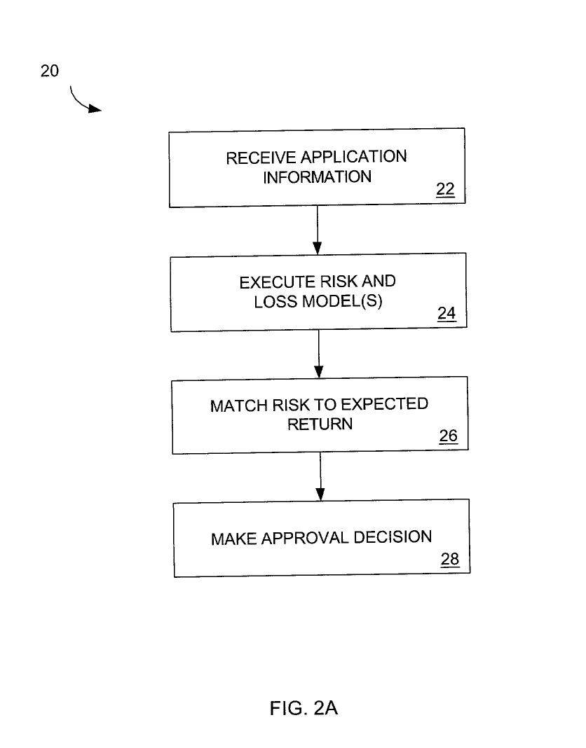

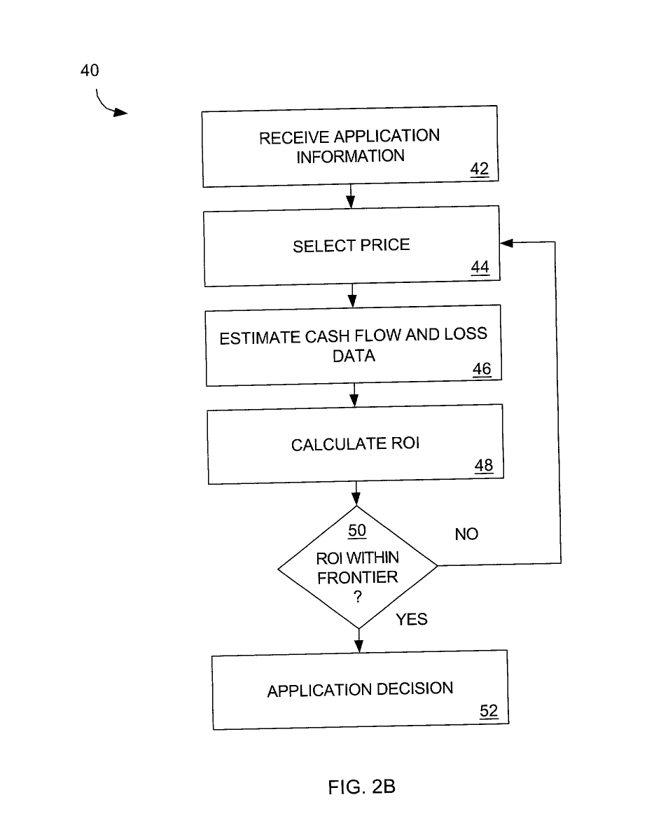

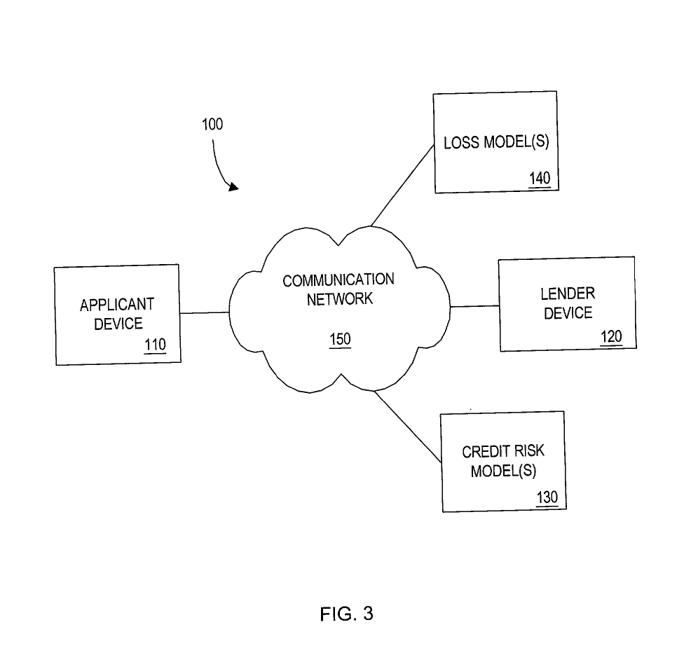

Referring now to FIG. 2, two financial application approval techniques will now be described. FIG. 2A depicts a process 20 for approving an application for a financial product using features of the present invention. Process 20 begins at 22 where application information is received. This application information may be received directly from an applicant for a financial product such as a loan or a lease, or it may be received from an intermediary, such as a loan officer at a car dealership. In one embodiment, the application information is entered at an applicant device 110 and transmitted to a lender device 120 via a communication network 150 (FIG. 3). In other embodiments, the application information may be communicated to a lender in any of a number of different ways known in the art (e.g., via telephone, facsimile, mail, etc.).

The nature and extent of the application information received may vary depending on the particular needs of the financial institution and also depending on the nature of the financial product for which approval is sought. In general, application information received at 22 may include information identifying the application, information identifying collateral to be pledged in security of the financial product, and information regarding the financial aspects of the application.

For example, where the financial product is an automobile loan, the application information received may include: the applicant's social security number and contact information, a vehicle identification number (VIN) of the vehicle being purchased, mileage information regarding the vehicle, the amount of the requested loan, etc. Other information relating to the applicant's credit may also be received at this time, such as a credit rating of the applicant. This credit rating and other credit information may be received from a third party, such as a commercial credit rating service such as the service offered by Experian or the like. In one embodiment, the credit rating may be represented, for example, by a so-called “FICO” credit score. In other embodiments, the credit information may be generated after receipt of the application information. Those skilled in the art will recognize that any of a number of rating systems may be used, and that a combination of one or more systems may also be used to generate credit information used with embodiments of the present invention.

Once this application information has been received, processing continues at 24 where the system of the present invention operates to calculate risk and loss data for the particular applicant and for the particular financial product requested. For example, these risk and loss calculations may include calculations determining the probabilities of a number of different termination events occurring during the life of the financial product (e.g., early payoff of a lease, etc.). These risk and loss probabilities are transformed into financial loss numbers for the particular product. In particular, a probability of loss is generated representing the overall risk the application presents to the financial institution.

Processing continues at 26 where the system operates to match the risk calculated at 24 with an expected return on investment (ROI) for the application based on the requested financial product. Processing at 26 includes calculating the potential ROI for a particular application by calculating the expected net income (NI) and the annualized net investment (ANI) for the application, taking into account the gross loss severity calculated at 24. Once this ROI for the application is generated, the potential ROI is compared with the expected ROI (the ROI hurdle) for the calculated risk on the efficient frontier (where the efficient frontier is calculated as described in conjunction with FIG. 1 above and described in more detail in conjunction with FIG. 5 below).

According to the invention, the ROI hurdle is selected by comparing the risk calculated at 24 with the efficient frontier (generated, for example, using the process described in FIG. 1, above) established by the financial institution for that particular product. For example, if the product is an automobile loan having an expected effective term of 38 months, and if processing at 24 indicates that the applicant and transaction pose a 20% risk of loss, the financial institution will need to match a ROI hurdle of approximately 3.08% to fund the loan and meet corporate lending objectives. If the calculated ROI for the application is equal to or greater than the ROI hurdle on the efficient frontier (3.08% in this example), the application will be approved. If the calculated ROI for the application is less than the ROI hurdle on the efficient frontier, the application may be denied as not satisfying the financial institution's ROI hurdle. In some embodiments, a manual approval threshold may be established within which an application which would otherwise be denied may be subject to a second review.

In some embodiments, terms of the financial product may be adjusted to ensure that the calculated ROI meets or exceeds the ROI hurdle. For example, features of the present invention may be used to adjust the price and/or term of the financial product to ensure that the ROI hurdle is met. For example, pricing techniques such as described in co-pending, commonly-assigned U.S. patent application Ser. No. ______, filed herewith on Jun. 21, 2001 for “METHOD AND APPARATUS FOR RISK BASED PRICING” may be used. An example of an embodiment of the present invention used to perform risk based pricing will be described by now referring to FIG. 2B.

Referring now to FIG. 2B, a process 40 is shown according to another embodiment of the present invention. Process 40 may be conducted by, or on behalf of, a financial institution to allow the financial institution to make application pricing and approval decisions according to embodiments of the present invention. In particular, process 40 provides a method by which the financial institution can utilize ROI hurdle data (established using features of the present invention) in the approval and pricing of applications for financial products.

Process 40 begins at 42 where application information is received. This application information may be received directly from an applicant for a financial product such as a loan or a lease, or it may be received from an intermediary, such as a loan officer at a car dealership. The nature and extent of the application information received may vary depending on the particular needs of the financial institution and also depending on the nature of the financial product for which approval is sought. In general, application information received at 42 may include information identifying the application, information identifying collateral to be pledged in security of the financial product, and information regarding the financial aspects of the application.

For example, where the financial product is a car lease, the application information received may include: the applicant's social security number and contact information, a vehicle identification number (VIN) of the vehicle being leased, mileage information regarding the vehicle being leased, the amount of the requested lease, etc. Other information relating to the applicant's credit may also be received at this time, such as a credit rating of the applicant. This credit rating and other credit information may be received from a third party, such as a commercial credit rating service such as the service offered by Experian, TransUnion or Equifax based on Fair, Isaac models (generating so-called “FICO” scores). In other embodiments, the credit information may be generated after receipt of the application information. Those skilled in the art will recognize that any of a number of rating systems may be used, and that a combination of one or more systems may also be used to generate credit information used with embodiments of the present invention.

Once this application information has been received, processing continues at 44 where the system of the present invention operates to select an initial price of the requested financial product. A number of different initial prices may be used. For example, where the financial product is a loan, the initial price selected may be an annual percentage rate (APR) of zero or some amount less than the then-current market rates for loan products.

Once an initial price has been selected, processing continues at 46 where the system of the present invention operates to calculate cash flow and loss data for the particular applicant, for the particular financial product requested, at the initial price selected at 44. The expected cash flow can be calculated by estimating the costs associated with the product (e.g., origination expenses, collection costs, etc.) and expected income associated with the product (e.g., monthly payments, payoff amounts, etc.) for each month of the product for each of several termination scenarios for the product (these termination scenarios will be discussed further below). The loss data may be estimated by determining the probabilities of a number of different termination events occurring during the life of the financial product (e.g., early payoff of a lease, etc.) based on the initial price. The expected cash flow and loss data calculated at 46 are used to estimate a potential ROI for the particular application at the price selected at 44. Typically, the price required to achieve a reasonable ROI for a particular product increases with the risk of a particular applicant. A high risk applicant will require a higher priced product (e.g., a loan with a higher APR) to achieve a desired ROI.

Processing continues at 48 where a return on investment (ROI) for the application based on the selected initial price for requested financial product is calculated. In particular, the ROI is based on the expected net income (NI) and the annualized net investment (ANI) is calculated, taking into account the expected cash flow and loss data calculated at 46. Once this ROI for the application at the initial price is calculated, processing continues to 50 where a determination is made whether the calculated ROI is within the efficient frontier calculated as described above in conjunction with FIG. 1, for example. If the calculated ROI for the application does not fall within the efficient frontier (e.g., the calculated ROI is lower than desired), the financial institution knows that the price for the product is too low and should be adjusted upward. If the calculated ROI for the application is higher than the efficient frontier at a particular level of risk, the price for the product is likely too high and should be adjusted downward. Thus, features of embodiments of the present invention may be used to help ensure that pricing of financial applications is done in an efficient and repeatable manner.

If processing at 50 indicates that the calculated ROI for an application based on the initial price is not within the efficient frontier, processing reverts to 44 where a further price is selected. In one embodiment, a binary search approach to determining the appropriate price is used. Using this embodiment, the first price selected at 44 is selected as the mean of a range, where the lower bound of the range is a price of zero, and the higher bound of the range is a price equal to the total amount of the application (e.g., if the financial product is a loan for $20,000, the upper bound will be $20,000, and the initial price to test will be $10,000). If processing at 50 indicates that the calculated ROI for this initial price is below the efficient frontier or target ROI (which it likely will), processing at 44 will select a next price which is the mean of of the range between the lower bound and the last selected price (in the example, the lower bound will remain $0, the upper bound will become $10,000, and the mean will become $5,000). This process will repeat until the system of the invention focuses in on a price that satisfies the target ROI.

Once this new price has been established, processing continues through steps 46-50 as described above. At 50, again, a determination is made whether the application based on the new price will provide a calculated ROI within the financial institution's established target for ROI. If the updated price still does not realize a calculated ROI that falls within the efficient frontier, processing again reverts to 44 where the process is again repeated. This repetitive search for a price which satisfies the financial institution's target for ROI may continue for a number of iterations until an appropriate price is found or until the application is ultimately rejected.

When processing at 50 indicates that the calculated ROI is within the efficient frontier, processing continues to 52 where an application decision is made. A financial institution may establish rules where an application may be automatically approved if a price can be found which satisfies the institution's target ROI. In some embodiments, the financial institution may establish rules which requires further inquiry into an application if the application is not within a certain automatic threshold. Other rules and procedures may be established, as will now be apparent to those skilled in the art, to allow efficient approval of applications.

Similar techniques may be used to modify the term or other conditions of the financial product to arrive at the appropriate risk/return point in the efficient frontier for that particular financial product. Other loan approval techniques may also be used, such as those set out in co-pending, commonly-assigned U.S. patent application Ser. No. ______, filed herewith on Jun. 21, 2001 for “METHOD AND APPARATUS FOR LOAN APPROVAL”.

The result is a system and method which further reduces the amount of human or manual intervention and the number of human judgment calls involved in financial product approval processes. Further, the system and method allow an entity such as a financial institution to establish and enforce expected ROI objectives for a variety of types of financial products. According to one preferred embodiment, features of the present invention may be implemented on an automated system such as the system shown and described in conjunction with FIG. 3. Referring now to FIG. 3, a system 100 pursuant to one embodiment of the present invention is shown. System 100 includes at least one applicant device 110 in communication with at least one vendor device 120. Vendor device 120 is in communication with one or more credit risk and loss model(s) 130, 140.

As used herein, devices (such as applicant device 110 and lender device 120) may communicate, for example, via a communication network 150, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology. Security measures, known to those skilled in the art, may be used with embodiments of the present invention to ensure data security and privacy as data is moved between devices and stored at devices such as devices 110 and 120.

In one embodiment of the present invention, each applicant device 110 communicates with one or more remote, World Wide Web (“Web”)-based lender devices 120 (e.g., configured as a Web-server) via the Internet. Although some embodiments of the present invention are described with respect to information exchanged using a Web site, according to other embodiments information can instead be exchanged, for example, via: a telephone, an Interactive Voice Response Unit (IVRU), electronic mail, a WEBTV®interface, a cable network interface, and/or a wireless communication system.

Applicant device 110 and lender device 120 may be any devices capable of performing the various functions described herein. For example, either of applicant device 110 and lender device 120 may be, for example: a Personal Computer (PC), a portable computing device such as a Personal Digital Assistant (PDA), or any other appropriate computing, storage and/or communication device.

Note that although a single applicant device 110 and a single lender device 120 are shown in FIG. 3, any number of applicant and/or lender devices 110, 120 may be included in system 100. In one currently preferred embodiment, system 100 will include a plurality of applicant devices 110 in communication with one or more lender devices 120. Similarly, any number of the other devices described herein may be included in 100 according to embodiments of the present invention. Note that the devices shown in FIG. 2 need not be in constant communication. For example, applicant device 110 may only communicate with lender device 120 via the Internet when appropriate (e.g., when an applicant for a financial product of a lender desires to submit an application for approval pursuant to the present invention).

Further note that applicant device 110 need not be operated by the individual applicant applying for a financial product. Instead, applicant device 110 may be operated on behalf of the individual applicant by, for example, a lender agent or another entity. Similarly, lender device 120 need not be operated by the financial institution offering the financial product for which an application is received; instead, lender device 120 may be operated on behalf of the lender by a service provider or other agent of the financial institution.

Credit risk and loss model(s) 130, 140 may be data stores or may be devices operated by third party service providers. Model(s) 130, 140 may also be model(s) established by and operated by or on behalf of the lender operating lender device 120. A number of different model(s) may be used in conjunction with embodiments of the present invention. These models, as will be described more fully below, are used in embodiments of the present invention to first identify a particular product tier for a given application, and then to generate an estimate of an expected loss for the application.

Any of a number of different types (and combinations) of models may be used. For example, a credit risk model 130 such as the models offered by Experian, TransUnion or Equifax (based on models from Fair, Isaac) may be used to generate a FICO score for a particular applicant. These credit risk models typically generate an assessment of an applicant's future risk of non-payment. Other proprietary and fee-based systems may also be used in conjunction with embodiments of the present invention. Data from one or more credit risk models 130 are used to identify an applicant's eligibility for one or more financial products as will be described further below.

One or more loss models 140 may also be used in conjunction with embodiments of the present invention. Those skilled in the art will recognize that a number of different proprietary and commercial systems have been developed for different types of financial products. In an embodiment used in conjunction with automobile financial products, such as vehicle leases or loans, account-level loss forecast models may be used which factor in the risk of one or more major termination events occurring. For example, for vehicle leasing, four early termination events may be considered: repossession, early payoff, insurance loss, and early turn-in (or “quasi-repossession”). One or more loss models 140 estimating the risk of occurrence of these events may be used in an embodiment of the present invention used to assist in the approval of vehicle lease applications.

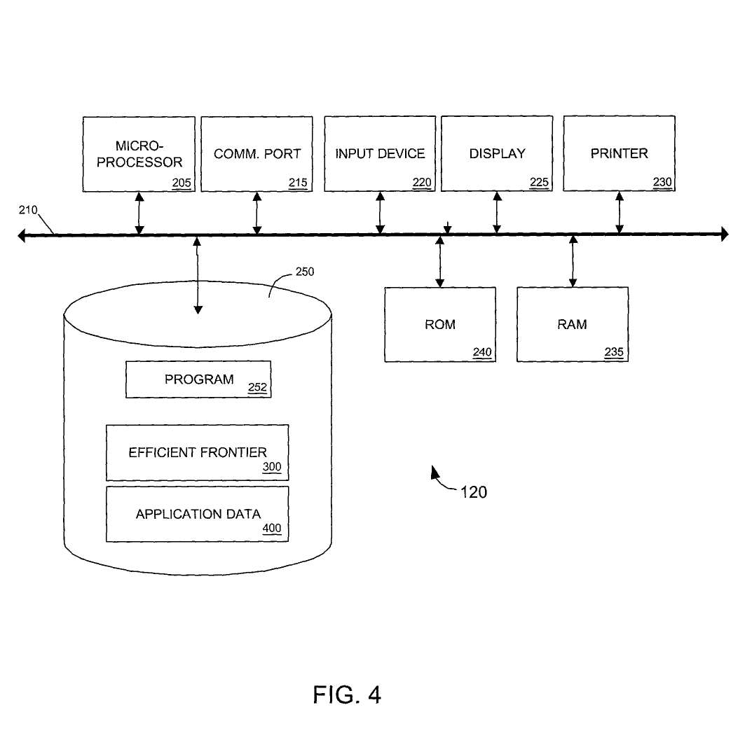

Details of one embodiment of lender device 120 will now be described by referring to FIG. 4 which is a block diagram of the internal architecture of an illustrative lender device 120. As illustrated, lender device 120 includes a microprocessor 205 in communication with a communication bus 210. Microprocessor 205 may be a Pentium, RISC-based, or other type of processor and is used to execute processor-executable process steps so as to control the elements of lender device 120 to provide desired functionality.

Also in communication with communication bus 210 is a communication port 215. Communication port 215 is used to transmit data to and to receive data from external devices, such as applicant device 110, and/or model(s) 130. Communication port 215 is therefore preferably configured with hardware suitable to physically interface with desired external devices and/or network connections. In one embodiment, applications for financial products are received from applicant device 110 via the Internet through communication port 215.

An input device 220, a display 225 and a printer 230 are also in communication with communication bus 220. Any known input device may be used as input device 220, including a keyboard, mouse, touch pad, voice-recognition system, or any combination of these devices.

Display 225, which may be an integral or separate CRT display, flat-panel display or the like, is used to output graphics and text to a user in response to commands issued by microprocessor 205. Such graphics and text may comprise a user interface as described herein. Printer 230 is an optional output device that produces a hardcopy of data using ink-jet, thermal, dot-matrix, laser, or other printing technologies. Printer 230 may be used to produce a hardcopy of application data or other data produced by or used with embodiments of the invention.

A random access memory (RAM) 235 is connected to communication bus 210 to provide microprocessor 205 with fast data storage and retrieval. In this regard, processor-executable process steps being executed by microprocessor 205 are typically stored temporarily in RAM 235 and executed there from by microprocessor 205. A read-only memory device (ROM) 240, in contrast, may be provided to permit storage from which data can be retrieved but to which data cannot be stored. Accordingly, ROM 240 is used to store invariant process steps and other data, such as basic input/output instructions and data used during system boot-up or to control communication port 215.

A data storage device 250 stores processor-executable process steps comprising a program 252. Microprocessor 205 executes processor-executable process steps of program 252 in order to perform the functions set forth herein.

The data stored in data storage device 250 may be in a compressed, uncompiled and/or encrypted format. Furthermore, stored in data storage device 250 may be program elements that may be necessary for operation of server 200, such as an operating system and “device drivers” for allowing microprocessor 205 to interface with devices in communication with communication port 215. These program elements are known to those skilled in the art, and need not be described in detail herein.

Data storage device 250 also stores efficient frontier data 300 and application data 400. Those skilled in the art will recognize that a number of different types of application data 400 may be received by lender device 120 and stored in (or accessible to) data storage device 250. For example, application data may include data identifying: an applicant, the applicant's contact information, collateral received (if any), credit information regarding the applicant, and other information which may be used by the financial institution to evaluate and fund (if approved) an application for a financial product. Examples of application data are described in co-pending and commonly-assigned application “METHOD AND APPARATUS FOR EVALUATING AN APPLICATION FOR A FINANCIAL PRODUCT”. In some embodiments, separate devices may be used to generate, retrieve, and/or store efficient frontier data 300 and application data 400.

Efficient frontier data 300 may include data generated by or on behalf of a financial institution pursuant to embodiments of the present invention, such as the embodiment described in conjunction with FIG. 1 above. Example efficient frontier data, presented in a graphical format, is shown in FIG. 5.

FIG. 5 depicts an exemplary efficient frontier calculated for three different automobile loan products with different expected effective terms: a 16 month product, a 38 month product, and a 60 month product. For each product, two end points are calculated by first selecting a low risk investment for the period (16, 38, and 60 months, respectively), and then by selecting a high risk investment for the period. In the example, the low risk investment selected is an investment in a Zero Coupon bond, while the high risk investment selected is an investment in the S&P 500. The end points and the resulting efficient frontier were calculated as follows (the following description details the calculations performed to arrive at the efficient frontier for the loan with an expected effective term of 38 months; similar calculations were used to generate the efficient frontier for the other two products).

The ROI for each of the two points selected (as described above in conjunction with FIG. 1, a low risk investment and a higher risk investment are selected) was calculated using the following series of formulas:

ROI=Lifetime NI/Lifetime ANI; (1)

Lifetime NI=Lifetime EBIT−Lifetime Interest Expense−Lifetime Taxes; (2)

Lifetime EBIT=Initial Investment* R_{Life}; (3)

Bond: R_{Life}=(1+Return Per Year)^{(Life/12)}−1; (4)

S&P500: R_{Life}=(S&P500_{Life}/S&P500)−1; (5)

Lifetime Interest Expense=Debt Interest+Pref. Eq. Interest; (6)

Debt Interest=Debt₀*((1+Yearly Cost of Funds)^{(Life/12)}−1); (7)

Debt₀=(Init. Investment*(Total Leverage−1)/Total Leverage); (8)

Total Leverage=Total Capital/Total Equity; (9)

Pref. Eq. Interest=Pref Eq₀*((1+Pref Stock Div. Rate)^{(Life/12)}>−1); (10)

Pref. Eq₀=Pref. Eq. Leverage* Init. Investment; (11)

Pref. Eq. Leverage=Pref. Eq./Total Capital; (12)

Pref. Stock Dividend Rate=Cost of Pref. Equity; (13)

Lifetime Taxes=Lifetime Taxes*Tax Rate; (14)

Lifetime ANI=Init. Investment*(2*Life−1)/(2*Life). (15)

For the low risk investment (in the example set forth herein, an investment in a Zero Coupon bond for the term), the ROI calculation resulted in a zero risk (zero volatility) investment with a ROI of approximately 1.47% (assuming a tax rate of 39.55% and a yearly market yield of 7.30% among other assumptions). This zero volatility point is plotted on the efficient frontier depicted in FIG. 5. For the high risk investment, the ROI calculation was repeated for each year the S&P 500 has been in existence, assuming an investment was made for each month of the period the S&P 500 has been in existence and the investment was maintained for the period (here, 38 months). From this series of calculations, an average ROI was established (approximately 6.8%). The volatility or risk associated with the investment was calculated as the span (the difference between the 95th percentile return and the 5th percentile return) which was calculated as 66.28%. That is, at approximately 66.28% volatility, the S&P500 returned approximately 6.8% for assets invested for a period of 38 months. This point is shown in FIG. 5. The efficient frontier line for the automobile loan product with an expected effective term of 38 months is thus calculated as having a slope of 8.06% with an intercept at 1.47% ROI (at zero volatility).

Similar calculations were conducted to establish efficient frontiers for the other two example financial products (loans having expected effective terms of 16 and 60 months, each having slopes of 6.52% and 8.92% with intercepts of 0.59% and 2.48% respectively). According to the invention, this information may be used to assist in making decisions regarding the approval and funding of financial product applications. Those skilled in the art will recognize that other investment choices may be made to generate efficient frontiers having greater or lesser risks or returns. Further, frontiers may be established for other types of financial products for which volatility may be measured (e.g., automobile leases, real estate loans, etc.). The result is a system and method which improves the ability of a financial institution or other entity to make informed application approval or denial decisions.

Although the present invention has been described with respect to a preferred embodiment thereof, those skilled in the art will note that various substitutions may be made to those embodiments described herein without departing from the spirit and scope of the present invention.

What is claimed is:

1. A method of matching a level of risk to an expected return for a financial product, the method comprising:
selecting a first and a second investment option;
selecting a duration;
calculating a risk and a corresponding return on investment for each of said investment options based on said duration; and
calculating an efficient frontier between said first and second investment options, said efficient frontier defining a plurality of risks and corresponding expected returns on investment for said financial product.

2. The method of claim 1, wherein said first investment option is a low risk option.

3. The method of claim 1, wherein said first investment option is a borrowing rate.

4. The method of claim 1, wherein said second investment option is a higher risk option than said first investment option.

5. The method of claim 1, wherein said duration is a duration of said financial product.

6. The method of claim 1, wherein said financial product is an automobile loan.

7. The method of claim 1, wherein said corresponding return on investment for each of said investment options are calculated by
determining an estimated lifetime net income for said investment option;
determining an estimated lifetime annualized net income for said investment option; and
dividing said estimated lifetime net income by said annualized net income.

8. The method of claim 1, wherein said efficient frontier is calculated by identifying a slope of a frontier between said first and said second investment options.

9. A method of evaluating an application for a financial product, the method comprising:
establishing an efficient frontier defining a plurality of expected returns on investment associated with a plurality of risks of loss;
receiving application data defining an application for a financial product;
estimating a calculated risk of loss associated with said application;
calculating, based at least in part on said expected loss data, a calculated return on investment of said application; and
comparing said calculated return on investment to an expected return on investment associated with said calculated risk of loss.

10. The method of claim 9, further comprising:
approving said application if said calculated return on investment is greater than or equal to said expected return on investment associated with said calculated risk of loss.

11. The method of claim 9, further comprising:
rejecting said application if said calculated return on investment is less than said expected return on investment associated with said calculated risk of loss.

12. The method of claim 9, further comprising:
increasing a price of said financial product if said calculated return on investment is less than said expected return on investment associated with said calculated risk of loss;
wherein said price is selected to increase said calculated return on investment.

13. A method of pricing a financial product, comprising:
establishing an efficient frontier defining a plurality of expected returns on investment (ROI) associated with a plurality of risks of loss;
receiving application data defining an application for a financial product;
selecting a price for said financial product;
calculating, based at least in part on said application data, expected cash flow data;
calculating, based at least on said expected cash flow data and said price, a potential ROI for said application;
comparing said potential ROI with said expected ROI at a given risk of loss; and
approving said application with said price if said potential ROI is within a target range of said expected ROI.

14. The method of claim 13 wherein said application data includes at least one of: applicant information; collateral information; and payment information.

15. The method of claim 13, further comprising:
repeating said selecting a price, calculating expected cash flow data, and calculating a potential ROI if said potential ROI is not within said target range.

16. The method of claim 13, further comprising calculating expected loss data, wherein said calculating comprises:
executing an account level loss forecast model;
executing a termination event model; and
calculating an expected loss in response to the execution of the account level loss forecast model and the execution of the termination event model.

17. A method for matching a level of risk to an expected return for a financial product, the method comprising:
selecting a first investment option, wherein said first investment option is a low risk option;
selecting a second investment option, wherein said second investment option is a higher risk option than said first investment option;
determining an estimated lifetime net income for said first and second investment options;
determining an estimated lifetime annualized net income for said first and second investment options;
dividing said estimated lifetime net income by said annualized net income for said first and second investment options to determine a corresponding return on investment for each of said first and second investment options;
calculating a risk for each of said corresponding returns on investment each of said investment options based on said duration; and
calculating an efficient frontier between said first and said second investment options, said efficient frontier defining a plurality of risks and corresponding returns on investment for said financial product.

18. A system for for matching a level of risk to an expected return for a financial product having a duration, the system comprising:
a processor;
a communications device, in communication with said processor; and
a memory unit in communication with said processor and storing a program, wherein said processor is operative with said program to:
select a first investment option and a second investment option;
calculate a risk and a corresponding return on investment for each of said investment options based on said duration; and
calculate an efficient frontier between said first and said second investment options, said efficient frontier defining a plurality of risks and corresponding returns on investment for said financial product.

19. An apparatus for matching a level of risk to an expected return for a financial product having a duration, the system comprising:
means for selecting a first and a second investment option;
means for calculating a risk and a corresponding return on investment for each of said investment options based on said duration; and
means for calculating an efficient frontier between said first and said second investment options, said efficient frontier defining a plurality of risks and corresponding returns on investment for said financial product.

20. A system for pricing a financial product, comprising:
a processor;
a communications device, in communication with said processor, receiving application data defining an application for a financial product;
a memory unit in communication with said processor and storing a program, wherein said processor is operative with said program to:
establish an efficient frontier defining a plurality of expected returns on investment (ROI) associated with a plurality of risks of loss;
select a price for said financial product;
calculate, based at least in part on said application data, expected cash flow data;
calculate, based at least on said expected cash flow data and said price, a potential ROI for said application;
compare said potential ROI with said expected ROI at a given risk of loss; and
approve said application with said price if said potential ROI is within a target range of said expected ROI.
